(19) United States
(12) Patent Application Publication
(10) Pub. No.: US 2024/0100624 A1
(43) Pub. Date: Mar. 28, 2024

(54) SOLID-STATE JOINING OF FEATURES TO CAST PARTS

(71) Applicant: MELD Manufacturing Corporation, Christiansburg, VA (US)

(72) Inventors: Nanci Hardwick, Blacksburg, VA (US); Chase Cox, Radford, VA (US)

(21) Appl. No.: 18/482,785

(22) Filed: Oct. 6, 2023

Related U.S. Application Data
(63) Continuation of application No. 17/220,214, filed on Apr. 1, 2021, now abandoned.
Application No. 17/220,214 is a continuation of application No. 16/115,044, filed on Aug. 28, 2018, now abandoned.

(51) Int. Cl. B23K 20/12; B23K 20/227; B23K 20/233; B33Y 10/00

(52) U.S. Cl. CPC B23K 20/1215; B23K 20/1205; B23K 20/124; B23K 20/1245; B23K 20/1255; B23K 20/128; B23K 20/129; B23K 20/1295; B23K 20/227; B23K 20/2275; B23K 20/2333; B23K 20/2336; B33Y 10/00; B23K 2103/02

(57) ABSTRACT

Solid-state joining of preformed features, such as bosses, flanges, gaskets, centralizers and other features to substrates or cast parts by a solid-state additive manufacturing process is disclosed. Joining can be between same or different materials using same, similar or dissimilar filler material than the materials of the feature and the part that need to be joined.

### CROSS-REFERENCE TO RELATED APPLICATIONS

The present application claims priority to and is a Continuation of U.S. patent application Ser. No. 16/115,044 filed Aug. 28, 2018. The present application is related to U.S. patent application Ser. No. 15/334,392 filed Oct. 26, 2016 (which issued as U.S. Pat. No. 10,105,790 on Oct. 23, 2018); U.S. patent application Ser. No. 14/640,077 filed Mar. 6, 2015 (which issued as U.S. Pat. No. 9,511,445 on Dec. 6, 2016); U.S. patent application Ser. No. 14/573,430 filed Dec. 17, 2014 (which issued as U.S. Pat. No. 9,266,191 on Feb. 23, 2016); U.S. patent application Ser. No. 15/829,038 filed Dec. 1, 2017 (which issued as U.S. Pat. No. 10,500,674 on Dec. 10, 2019); and U.S. patent application Ser. No. 14/954,104 filed Nov. 30, 2015 (which issued as U.S. Pat. No. 9,862,054 on Jan. 9, 2018). The disclosures of these applications are hereby incorporated by reference herein in their entireties.

### BACKGROUND OF THE INVENTION

### Field of the Invention

The present invention is in the fields of solid state manufacturing, material joining and additive manufacturing. In particular, the invention is in the field of additive friction-stir joining of materials.

### Description of Related Art

A range of processes based on friction stir and associated frictional heat offer many advantages and overcome the limitations of conventional joining processes. The advantages range from the choice of the filler material type and filler material form to varieties of the joining steps. In particular, closely related to the latter statement, the joining process can be used to join already made features (pieces) to a cast part or substrate or can be used to print the whole piece/feature on a cast part or substrate.

The basics of the inventive processes are: heat is generated by the friction between the rotating tool and the workpiece surface; the generated heat enables a significant amount of plastic deformation in the vicinity of the rotating tool; a substantial strain is imparted to the workpiece material resulting in refinement of its micro-structure; the material adjacent to the tool softens and the softened material is optionally mechanically stirred and/or mixed and joined with the filler material added via the passageway of the tool using mechanical pressure supplied by the tool shoulder.

Some of the benefits of the inventive processes are as follows: 1) a solid-state, and often a single-step process; 2) the possibility to work with thermally-sensitive and/or air-sensitive materials; 3) no prior surface preparation is required, but can be used; 4) provides good dimensional stability (minimal distortion of the parts due to being performed in a solid state); 5) enables good control over the processed workpiece's surface depth; 6) consumes little energy since the heat is generated by friction, and thus, no external energy is needed, but can be used, to for example cause plastic deformation of the material; facilitates excellent bonding properties with the substrate (workpiece), has a good reproducibility, as well as offers potential for a process automation. Therefore, the inventive systems and associated processes and technologies are considered to be environmentally-friendly processes and technologies mainly due to the relatively low external energy costs required, and the fact that no harsh chemicals are used and no exhaust gases and fumes are generated.

According to embodiments, the manufacturing system is capable of performing any one or more of the inventive processes, such as the coating process, the joining process, the surface functionalization process, the repair or fabrication of 3D- and 4D-structures processes, and is intrinsically different from any of the friction stir systems known in the art. The main difference from the known art is that the inventive system performs the process as a solid-state thermo-mechanical additive process by adding the material, known as a filler material, to the workpiece(s) to generate a joint, repair the defective spot, coat a part, or generate an additive 3D- or 4D-structure. The inventive process is a solid-state process that deposits the filler material on a workpiece or in a workpiece, mixes and homogenizes the materials (filler and workpiece material) with the aid of frictional heating which occurs due to the severe friction in the processed zone and generates chemical or physical bonding between the deposited material and the workpiece without the filler material melting.

The workpiece used in the inventive process can be of almost any shape and size including but not limited to flat or curved substrates, joints, rails, pipes, window frames, automotive and aerospace parts and structures, and many other structures.

Friction-stir processing provides for the solid state joining of pieces of metal at a joint region through the generation of frictional heat at the joint and opposed portions of the metal pieces by cyclical movements of a tool piece that is harder than the metal pieces. An example of this is provided by International Application Publication No. PCT/GB1992/002203, incorporated by reference herein in its entirety. Frictional heat produced between the substrate and the tool during the process causes the opposed portions of the substrate to soften, and mechanical intermixing and pressure cause the two materials to join. Typically, two materials are placed side-by-side and are joined together at the seam between the two.

Additive friction stir techniques employ an additive process for joining materials. See, for example, U.S. Pat. Nos. 8,636,194; 8,632,850; 8,875,976; and 8,397,974, the contents of which are hereby incorporated by reference in their entireties. Additive friction stir processes use shear-induced interfacial heating and plastic deformation to deposit metallic coatings onto metal substrates. Coatings prepared using additive friction stir techniques have bond strengths superior to those of thermally sprayed coatings, and have the potential to enhance corrosion resistance, enhance wear resistance, repair damaged or worn surfaces, and/or act as an interfacial layer for bonding metal matrix composites. In this process, the coating material, such as a metal alloy, is forced through a rotating spindle to the substrate surface. Frictional heating occurs at the filler/substrate interface due to the rotational motion of the filler material, such as a rod, at an angular velocity and applied downward force. The mechanical shearing that occurs at the interface acts to disperse any oxides or boundary layers, resulting in a metallurgical bond between the substrate and coating. As the substrate moves relative to the tool, the coating is extruded under the rotating shoulder of the stirring tool.

Solid state joining processes that are currently available usually do not use additional filler material and typically require plunging of a profiled tool into the base metal. The plunging of the tool tends to cause considerable tool wear making the tool unusable and also introduces contaminates. This problem becomes more severe with materials having a high melting point such as steel, nickel-based alloys, cobalt-based alloys, titanium-based alloys and refractory metals. In addition, the manufacturing of profiled tools is very challenging, time consuming and costly. Thus, there is a need in the art for new solid state joining processes.

### SUMMARY OF THE INVENTION

According to embodiments, the present invention provides a method for solid-state joining of a preformed feature to a substrate. The method includes placing the feature and the substrate in communication with or in close proximity to each other, feeding a filler material through a tool, rotating and translating the tool relative to the feature and/or the substrate such that plastic deformation of the filler material causes the feature and the substrate to be joined by way of the filler material.

According to an aspect of this embodiment, the tool is rotated and translated around one or more edges of the feature such that the filler material (also referred to as feedstock, coating material, or a consumable) forms a joint between the feature and the substrate.

According to another aspect of this embodiment, the feature is held against the substrate in a forming cavity, and the tool is rotated and translated relative to the substrate such that extrusion of the substrate and/or filler material into the forming cavity causes joining of the feature with the substrate.

According to another aspect of this embodiment, the feature is any prefabricated or preformed feature or structure.

According to another aspect of this embodiment, the feature is or includes a boss, flange, gasket, or centralizer.

According to another aspect of this embodiment, the substrate has a flat, circular, and/or hollow geometry or configuration.

According to another aspect of this embodiment, the feature, substrate, and/or filler material comprise the same or similar materials.

According to another aspect of this embodiment, one or more of the features, substrates, and/or filler material (feedstock) comprise different materials.

These and additional embodiments and aspects of the invention will be further described in the foregoing Detailed Description.

### BRIEF DESCRIPTION OF THE DRAWINGS

The accompanying drawings illustrate certain aspects of embodiments of the present invention and should not be used to limit the invention. Together with the written description the drawings serve to explain certain principles of the invention.

FIG. 1 is a schematic diagram showing a front cross-sectional view of a set up that can be used for joining materials 10A and 10B at joint line 11, where optionally nozzles 45 for inert gas shielding can be used.

FIG. 2 is a schematic diagram showing a side cross-sectional view of the joint configuration of FIG. 1 according to an embodiment of the invention.

FIG. 3 is a schematic diagram showing a cross section of a joining process during the joining of substrates according to an embodiment of the invention.

FIG. 4 is a schematic diagram showing a set up for joining materials 10A1 and 10B1 (without or with ribs) where a face of each of the substrates is machined and then the substrates are aligned and abutted against one another at the machined faces to form an inverted “V” groove shape at joint line 11A.

FIG. 5A is a schematic diagram showing joined plates with a rib formation/feature on the root according to an embodiment of the invention.

FIG. 5B is a schematic diagram showing joined plates with a minimal rib formation/feature on the root according to an embodiment of the invention.

FIG. 6A is a schematic diagram showing a set up for a method of performing a lap joint configuration according to an embodiment of the invention.

FIG. 6B is a schematic diagram showing a set up for a method of performing a V-shaped corner joint configuration according to an embodiment.

FIG. 7 is a schematic diagram showing a friction-stir tool with a continuous feeding system for the filler material that can be used in methods of the invention.

FIGS. 8A-B are diagrams of a joint produced using an embodiment of the additive friction stir methods of the invention, where FIG. 8A shows one side of the substrates joined (face side) and FIG. 8B shows the other side (root side).

FIG. 9 is a diagram of a cross section of the joint shown in FIGS. 8A-B.

FIG. 10 is a schematic representation of an embodiment of monolithic rib extrusion on a metallic substrate using the technology according to the invention. The forming die is semi-transparent for visual purposes only.

FIG. 11 is a schematic cross-sectional view of an embodiment of monolithic rib extrusion according to the invention.

FIG. 12 is a schematic representation depicting an embodiment of a process for fabricating multiple rib formations/features and/or various rib preforms using the joining methods according to the invention.

FIG. 13 is a schematic diagram showing various embodiments of preformed ribs joined to substrates according to the invention. Extrusion of ribs, attached or independent of a substrate, can be made with various geometries and sizes.

FIGS. 14A-14I are diagrams of various preformed features and structures that can be joined to a substrate or part by way of a joining process according to embodiments of the invention.

FIGS. 15A-C are diagrams of various preformed features and structures added to a previously made pipe or a flat substrate by way of a joining process according to embodiments of the invention.

FIG. 15D is a diagram showing the addition of asymmetrical features to a preformed structure by way of a joining process according to an embodiment of the invention.

FIGS. 16A and 16B are diagrams respectively showing cross-sectional and end views of attachment of a component to a tubular structure by way of an additive joining process according to an embodiment of the invention.

### DETAILED DESCRIPTION OF VARIOUS EMBODIMENTS OF THE INVENTION

Reference will now be made in detail to various exemplary embodiments of the invention. It is to be understood that in the text below the exemplary embodiments are not intended as a limitation on the invention. Rather, the following text is provided to give the reader a more detailed understanding of certain aspects and features of the invention.

As used herein, the term “additive manufacturing” refers to and is interchangeable with Additive Friction Stir and/or any process described herein, such as manufacturing processing using a rotatable and/or translatable tool that delivers feedstock through the tool and processes the feedstock and/or substrate in a manner to deform one or both of the feedstock and/or substrate, in whole or part, to allow for joining of the feedstock and substrate and/or one or more additional structural feature.

As used herein, the term “coating material” is used interchangeably with “filler material” and/or “feedstock” and/or “consumable” and/or “consumable material,” which each independently or collectively relate to an additive material which is fed through a throat of a rotating stirring tool as described in this disclosure.

As used herein, the term “feature,” “structure,” or “preformed feature” used in the context of the additive friction stir processes described herein includes any structure, typically a solid structural feature, capable of being joined to one or more substrate by an inventive process described herein. In embodiments, when referring to a preformed feature, the feature does not have to be made or formed by any particular method, only that one or more of such features is an existing structural object to be joined to one or more substrate. For example, as used herein, the term “preformed” when used to describe a feature or structure is used interchangeably with “prefabricated” and “already made,” and means any feature or structure previously manufactured by any process.

Various embodiments/aspects thereof and their features described below can be used singularly or in any combination as recognized by one skilled in the art.

Solid state joining of materials can be classified into diffusion welding processes and deformation welding processes. Diffusion welding processes typically employ longer processing times, higher temperatures and less pressure, whereas deformation welding processes typically employ higher pressure, higher temperatures and shorter processing times. Deformation welding can be employed for various joint configurations. The inventive additive friction stir process is one type of these deformation-based deposition processes, which can be utilized for joining materials and structures that are hard to be joined by other means. Since the methods can add materials along the joint line, using a forming plate in the back of the weld allows a stiffening rib to be formed in addition to joining.

From the materials perspective based on surface oxidation characteristics and melting point, each metal has a specific degree of deformation and temperature requirements for obtaining sound metallurgical bonding. For example, for ferrous metals the deformation requirement is about 81%, while aluminum alloys require 40-60%. The deformation helps in bringing two metallic surfaces together by breaking surface contaminations. The force required to deform the material decreases with temperature.

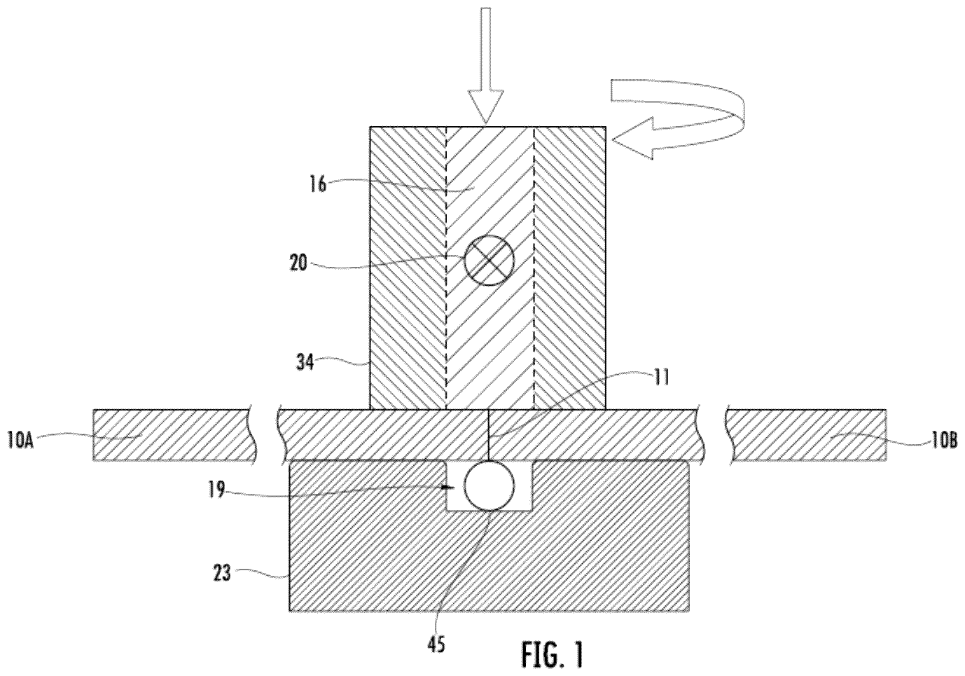

In embodiments of the present invention the required surface deformation is achieved by interaction of filler metal and tool, and additional bulk deformation is achieved during forming using the forming plate as shown in FIGS. 1-3. As shown, an additive friction stir method for joining substrates is provided, the method comprising: providing first and second substrates (10A and 10B) to be joined; providing a forming plate 23 comprising one or more forming cavities 19; placing the first and second substrates in communication with or in close proximity to the forming plate; placing the first and second substrates in communication with or in close proximity to each other (at joint line 11); rotating and translating an additive friction-stir tool relative to the substrates, while in contact with or not contacting the substrate(s); feeding a filler material 16 through the tool 34; deforming the filler material and the first and second substrates; and extruding 53 one or more of the filler material and the first and second substrates into one or more of the forming cavities of the forming plate.

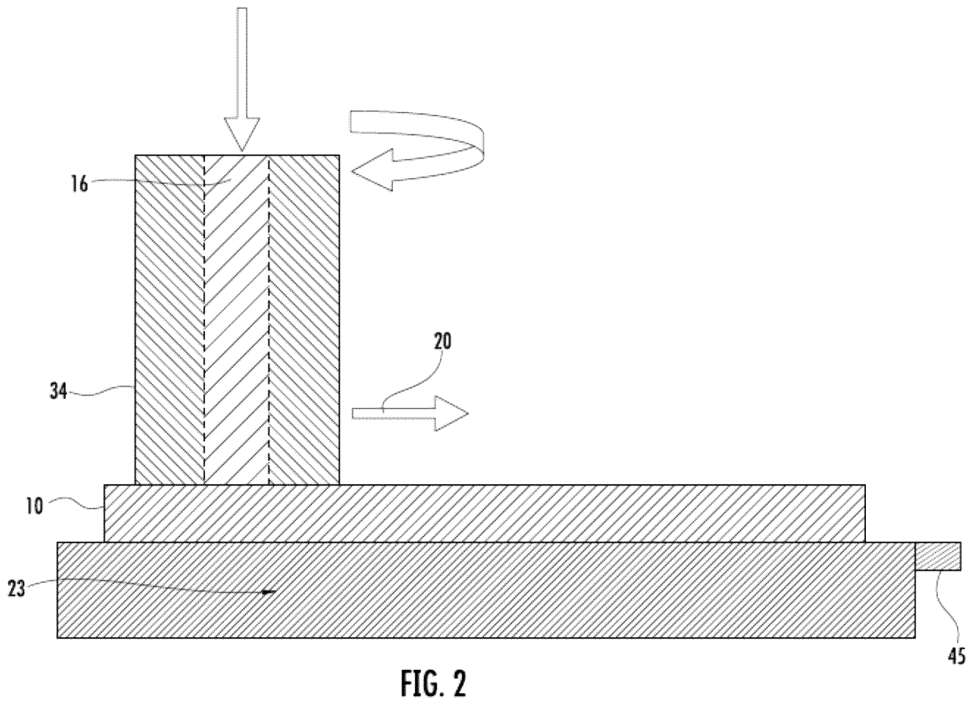

FIGS. 1-3 describe embodiments of a method of joining metallic materials with rib formation at the root for butt joint type configurations. FIG. 1 and FIG. 2 show that the base metal 10, 10A, and 10B is placed and firmly clamped onto the forming plate 23 without any lateral movement in such a way that joint line 11 is preferably disposed above the middle of forming groove 19. At this stage, a rotating cylindrical tool 34 (e.g., a non-consumable tool) with filler 16 interacts with the base metal 10, 10A, 10B along joint line 11 and generates frictional heat. Although the rotating tool 34 can be used to penetrate the substrate 10, 10A, 10B, in embodiments the rotating tool does not penetrate the base metal 10, 10A, 10B during translation. Likewise, although the tool can comprise a pin on the axis of rotation of the tool, the tool 34 can also have no such pin. The tool can have geometry on the shoulder of the tool such as projecting or profiled features capable of stirring any deformed metal, but in embodiments the face of the shoulder can also be flat or featureless.

Reference numeral 20 shows the direction of tool 34 traverse in FIGS. 1 and 2. While heat is being generated the filler metal 16 is fed through the tool 34 which generates additional heat and pressure. During the interaction of filler 16 and the rotating tool 34 with the base metal surface 10, 10A, 10B, heat and deformation required for solid state bonding between filler 16 and base metal 10, 10A, 10B is obtained at the surface. Upon further increase in contact pressure, due to the filler feeding, the base metal 10, 10A, 10B starts flowing into the grooves 19 in the forming plate 23, as shown in FIG. 3. During this stage the initial butting surface is eliminated.

FIG. 3 shows face reinforcement 51 as well as root formation 53 of base metal in the forming groove during joining. It is shown in such a way that the formation has not completely filled the forming groove. However, the geometry of the forming groove can be modified in order to control the shape and size of the root formation and filler feed rate can be adjusted in such way that the forming groove 19 is completely filled. In other embodiments the forming groove 19 is minimally filled, or a minimal void or forming groove is provided by the forming plate. The reinforcement/face formation of the weld is controlled by the filler feed rate and/or the tool position.

The hot base metal is protected from ambient atmosphere by the tool and additional shielding can be provided through additional forming grooves which are optional. The position of the shielding gas tube 45 beneath the base plate is shown in the embodiment in FIGS. 1 and 2, and it is placed ahead of the tool below the base plate in such a way that the shielding gas flows through the groove in the forming plate continuously without any interruption until the base metal is joined. The shielding gas protects the hot base metal from the ambient atmosphere and minimizes reaction with the forming plate.

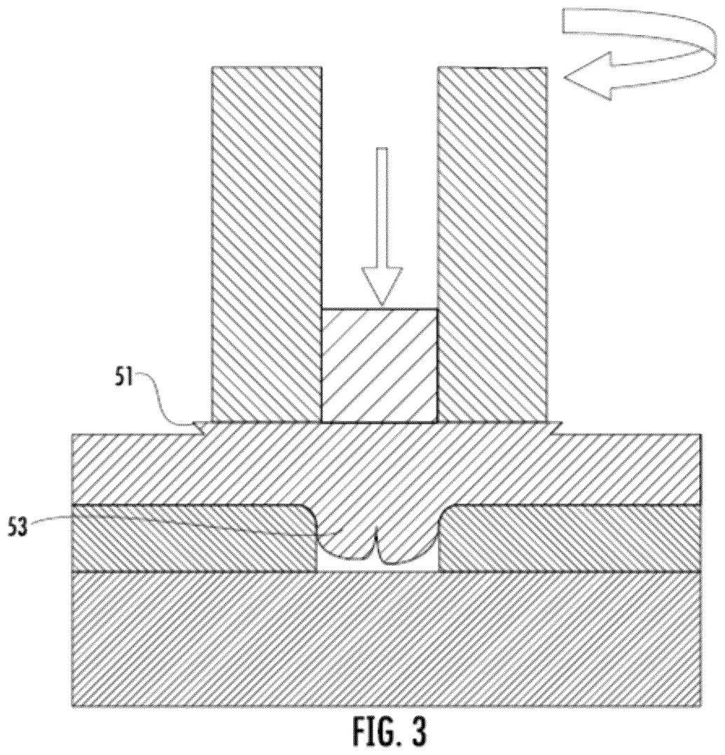

FIG. 4 shows an embodiment of a butt joint configuration and edge preparation of the base metal 10A1, 10B1 for joining metallic materials without/with minimal rib. In this case the forming plate 23 determines the minimal groove depth. In this configuration during the deformation stage the inclined surfaces of the inverted “V” groove disposed below joint line 11A are deformed to make a flat surface while achieving required deformation and temperature at the joint interface. Additionally, filler material can also be added to complete the joint. However, other butt joint configurations may fall within the methods of the invention, including a double “V”, single “U”, double “U”, single “J”, double “J”, single bevel, or double bevel. These and other joint configurations are published in “The Everyday Pocket Handbook on Welding Joint Details for Structural Applications”, published by the American Welding Society, Copyright 2004, incorporated by reference herein in its entirety.

The interaction of the tool with the base metal removes the oxide layer or any other form of contamination on the surface before the base metal interacts with the filler metal. The filler metal interacts with the contamination free surface of the base metal and metallurgically bonds with the base metal while the applied pressure on the filler metal deforms the base metal into the forming plate. During this process any un-bonded interface between the initial butt surfaces is moved to the forming plate when the material is being added on the top surface. If any un-bonded surface exists in the root of the weld, it can be optionally machined.

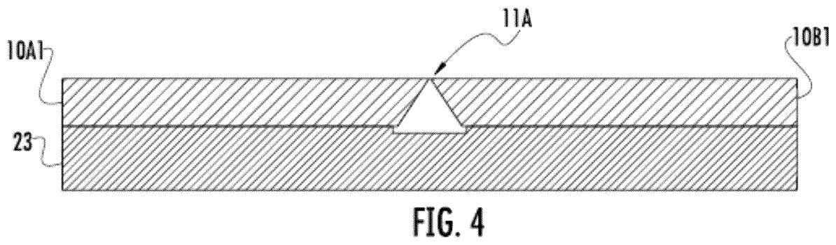

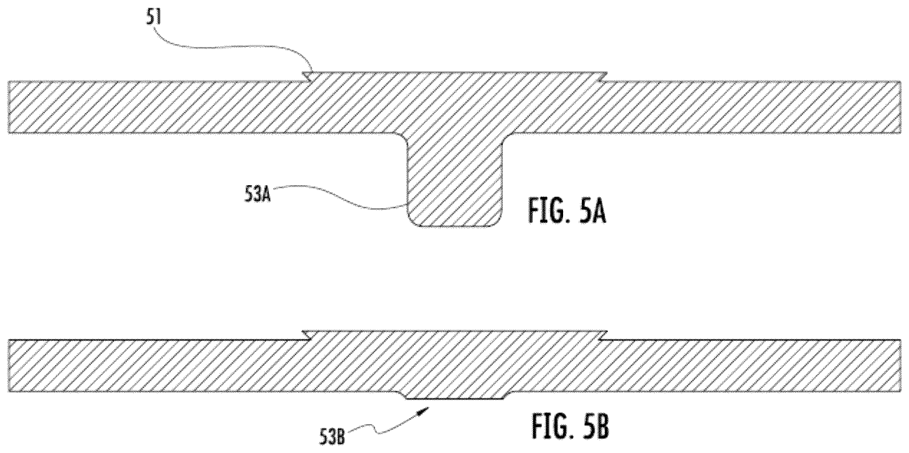

FIGS. 5A and 5B schematically show embodiments of the welded plates with and without rib formation along the weld line. FIG. 5A shows face reinforcement 51 where additional filler material is built up on the surface of the substrates joined using the process. FIG. 5A also shows ribs structure 53A on the root. FIG. 5B shows an area of root reinforcement 53B with no rib structure (or minimal root structure).

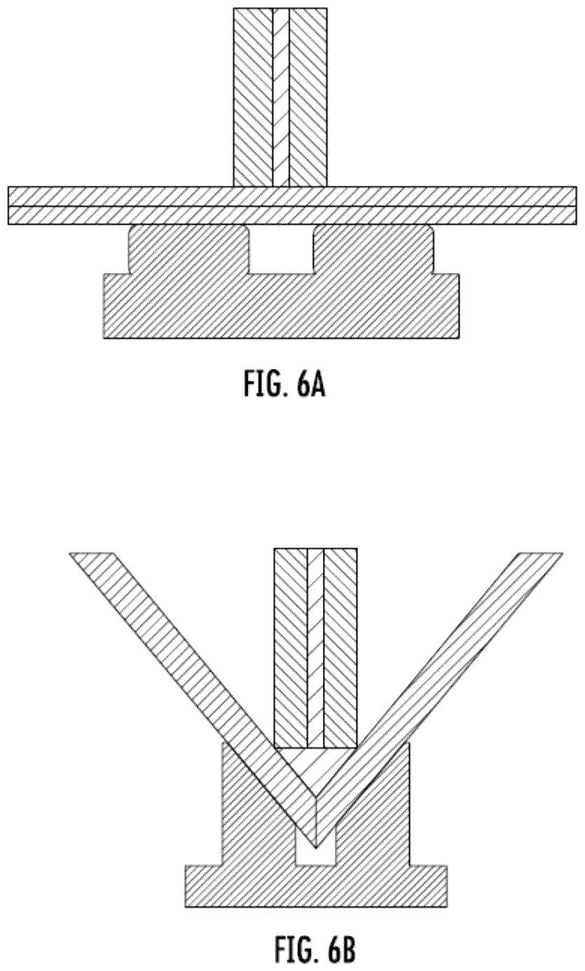

FIGS. 6A and 6B show various embodiments of forming plate design for lap joint and corner joint configurations, respectively. A method of preparing a lap joint can include a set up (shown in FIG. 6A) wherein the first substrate comprises a first face in communication with the forming plate; the first substrate comprises a second face disposed in a direction opposite the first face of the first substrate; the second substrate comprises a first face in communication with the second face of the first substrate such that the first substrate is sandwiched between the forming plate and the second substrate to provide for a lap joint between the first and second substrates; the second substrate comprises a second face disposed in a direction opposite the first face of the second substrate; the filler material is deposited on the second face of the second substrate and the deforming of the filler material and the first and second substrates creates the lap joint. The interaction of the filler material with the first and/or second substrates generates plastic deformation of and causes welding of the first and second substrates along the lap joint.

As shown in FIG. 6B, a method of preparing a corner joint can comprise providing first and second substrates to be joined; providing a forming plate comprising one or more forming cavities; placing the first and second substrates in communication with the forming plate; placing the first and second substrates in communication with each other to provide for a corner joint between the first and second substrates; rotating and translating an additive friction-stir tool relative to the substrates; feeding a filler material through the additive friction-stir tool; and deforming the filler material and the first and second substrates to create the corner joint. As illustrated, the first and second substrates can each comprise a first face with a slanted surface; the first face of the first substrate is in communication with the first face of the second substrate to provide for a corner joint between the first and second substrates; the first and second substrates each comprise a second face in communication with the forming plate; the filler material is deposited on a third face of each of the first and second substrates, which third face is disposed in a direction opposite the second face; and the filler material reinforces the corner joint at a concave portion of the corner joint along the third face of the first and second substrates.

The forming plate design and base metal edge preparation can be customized to fit the required joint configurations in achieving required temperature, pressure and deformation continuously along the joint line. Further, other joint configurations may fall within the scope of the methods of the invention, including Tee-joint, flange, flare, mechanical weld, angular weld, edge weld, and the like. Such joint configurations are readily understood by a skilled artisan.

In one embodiment, the forming plates are provided as a metal with a higher density, higher melting temperature, and/or increased hardness than the first and second substrate. This is to minimize the reaction of the forming plates with the first and second substrate. Additionally, the substrate plates may be provided by depositing filler material by the additive friction stir process to form a substrate in situ. The structure formed may or may not include a rib. Where a rib is formed, there is no limit to the length of the rib due to the addition of material from the stirring tool.

Various combinations of materials may serve as the filler material, or the first and second substrate. Suitable materials include using the same materials for each, or one or more material can have a difference in melting temperature, density, and/or hardness of up to about 50% of the other material(s), such as from 2-20%, including at least about 10%. In one embodiment, materials that have a higher melting temperature or that are denser or harder serve as the first substrate, and materials that have a lower melting temperature or are less dense or lighter serve as the filler material and/or second substrate.

Materials that may serve as the filler material or as the first and second substrate may include metals and metallic materials, polymers and polymeric materials, ceramic and other reinforced materials, as well as combinations of these materials. In embodiments, the filler material may be of a similar or dissimilar material as that of the first substrate and/or second substrate materials. The filler material and the first and second substrate may include polymeric material or metallic material, and without limitation include metal-metal combinations, metal matrix composites, polymers, polymer matrix composites, polymer-polymer combinations, metal-polymer combinations, metal-ceramic combinations, and polymer-ceramic combinations.

In one particular embodiment, the first and second substrates and/or the filler material are metal or metallic. The filer material, or the first substrate and second substrate may be independently selected from any metal, including for example Al, Ni, Cr, Cu, Co, Au, Ag, Mg, Cd, Pb, Pt, Ti, Zn, or Fe, Nb, Ta, Mo, W, or an alloy comprising one or more of these metals. In embodiments, the first and second substrates and/or the filler material are polymeric material. Non-limiting examples of polymeric materials useful as a filler material include polyolefins, polyesters, nylons, vinyls, polyvinyls, acrylics, polyacrylics, polycarbonates, polystyrenes, polyurethanes, and the like.

In still yet another embodiment, the filler material is a composite material comprising at least one metallic material and at least one polymeric material. In other embodiments, multiple material combinations may be used for producing a composite at the interface. The composite material is then extruded into a forming cavity of a forming plate disposed below the substrate.

In embodiments, the first substrate and second substrate may be provided as a sheet or plate, such as sheet metal or metallic plates, in a variety of dimensions for joining, including with a width and/or length of from about 1 inch to about 20 feet, such as for example 2′×2′, 2′×3′, 2′×4′, 3′×4′, 4′×4, 5′×5, 6′×4′, and the like. The size of the sheets is highly dependent on and can fit any desired application. Depths of the substrates as described above may be on the order of micrometers to centimeters.

In these additive friction stir process embodiments, the filler material (for example, solid bar or powder) can be fed through the rotating additive friction stir tool where frictional and adiabatic heating occurs at the filler/substrate interface due to the rotational motion of the filler and the downward force applied. The frictional and adiabatic heating that occurs at the interface results in a severe plastic deformation at the tool-metal interface. As the tool moves along the substrate along a vector overlying the forming cavity or groove (or with any relative motion between the substrate and tool), the plasticized metal can be extruded under the rotating shoulder of the tool into the forming cavity or groove.

The filler materials can be in several forms, including but not limited to: 1) metal or plastic powder or rod of a single or composite composition; 2) matrix metal and reinforcement powders can be mixed and used as feed material; or 3) a solid rod of matrix can be bored (e.g., to create a tube or other hollow cylinder type structure) and filled with reinforcement powder, or mixtures of metal matric composite and reinforcement material. In the latter, mixing of the matrix and reinforcement can occur further during the fabrication process. In embodiments, the filler material may be a solid metal rod. In one embodiment, the filler material is aluminum.

In embodiments, the filler material is joined with a substrate using frictional heating and compressive loading of the filler material against the substrate and a translation of the rotating friction tool. The filler material may be a consumable material, meaning as frictional heating and compressive loading are applied during the process, the filler material is consumed from its original form and is applied to the substrate. Such consumable materials can be in any form including powders, pellets, rods, and powdered-filled cylinders, to name a few. More particularly, as the applied load is increased, the filler material and substrate at the tool-substrate interface become malleable as a result of frictional and adiabatic heating and are caused to bond together under the compressive load. In one embodiment, the deformed metal is then extruded into the forming cavity to form a rib.

The rotating tool may take a variety of forms. For example, the tool can be configured as described in any of U.S. Published Application Nos. 2008/0041921, 2010/0285207, 2012/0009339, and 2012/0279441, 2012/0279442, as well as International Patent Application Publication No. WO2013/002869, which references are incorporated by reference herein in their entireties. Friction-based fabrication tooling for performing methods of the invention are preferably designed or configured to allow for a filler material to be fed through or otherwise disposed through an internal portion of a non-consumable member, which may be referred to as a throat, neck, center, interior, or through hole disposed through opposing ends of the tool. This region of the tool can be configured with a non-circular through-hole shape. Various interior geometries for the tooling are possible. With a non-circular geometry, the filler material is compelled or caused to rotate at the same angular velocity as the non-consumable portion of the tool due to normal forces being exerted by the tool at the surface of the tool throat against the feedstock. Such geometries may include a square through-hole and an elliptical through-hole as examples. In configurations where only tangential forces can be expected to be exerted on the surface of the filler material by the internal surface of the throat of the tool, the feed stock will not be caused to rotate at the same angular velocity as the tool. Such an embodiment may include a circular geometry for the cross-section of the tool in combination with detached or loosely attached feedstock, which would be expected to result in the filler material and tool rotating at different velocities. As used in this disclosure, the terms “additive friction-stir tool”, “friction-stir tool”, “non-consumable friction-stir tool”, and “rotating non-consumable friction-stir tool” may be used interchangeably.

In embodiments the throat of the tool may be shaped with a non-circular cross-sectional shape. Further desired are tooling wherein the throat of the tool is shaped to exert normal forces on a solid, powder, or powder-filled tube type filler material disposed therein. Embodiments may also include features to ensure the frictional heating and compressive loading are of a degree sufficient to enable mixing of dispensed filler material with material of the substrate at a filler-substrate interface.

More specifically, the magnitude of force transferred from the rotating tool to the filler material is dependent on the coefficient of friction between the two. Thus, if the coefficient of friction is significantly low and the inertial force required to induce rotation of the filler material is significantly high, then the tool can rotate without inducing rotation (or with inducing rotation at a lower speed than the tool) in the cylindrical filler material. Under some circumstances during operation, differences in rotational velocity between the tool and the filler within the tool can lead to some filler material being deposited inside the tool, an accumulation of which can be problematic. Having the specific interior tool geometries described in this disclosure can reduce this issue, such as appropriately sized square-square or elliptical-elliptical shaped filler-dispenser geometries. Another way of reducing the difference in rotational velocity between the tool and the filler material is to manufacture filler material rods to fit tightly within the throat of the tool, or to otherwise tightly pack the filler material into the throat of the tool.

Any shape of the cross section of the interior of the tool that is capable of exerting normal forces on a filler material within the tool can be used. The throat surface geometry and the filler material geometry can be configured to provide for engagement and disengagement of the tool and filler material, interlocking of the tool and feed material, attachment of the tool and feed material, whether temporary or permanent, or any configuration that allows for the filler material to dependently rotate with the tool.

The interior surface shape of the tool (the throat) and the corresponding shape of the filler material may not be critical and can be constructed in a manner suitable for a particular application. Shapes of these surfaces can include, but are by no means limited to, square, rectangular, elliptical, oval, triangular, or typically any non-circular polygon. Additional shapes may include more distinctive shapes such as a star, daisy, key and key-hole, diamond, to name a few. Indeed, the shape of the outside surface of the filler material need not be the same type of shape as the surface of the throat of the tool. For example, there may be advantages from having a filler material rod with a square cross-section for insertion into a tool throat having a rectangular cross-section, or vice-versa where a filler material rod having a rectangular cross-section could be placed within a tool throat having a square cross-section in which the corners of the filler material rod could contact the sides of the square throat instead of sides contacting sides. Particular applications may call for more or less forces to be exerted on the filler material within the throat during operation of the tool. With concentric shapes and very close tolerance between the filler material and the tool certain advantages may be realized. Additionally, different shapes may be more suitable for different applications or may be highly desired due to their ease of manufacturing both the interior of the tool and corresponding filler material rods. One of ordinary skill in the art, with the benefit of this disclosure, would know the appropriate shapes to use for a particular application.

Additional embodiments of additive friction stir tools according to the invention can include a tool with a throat, where the filler material and throat are operably configured to provide for continuous feeding of the filler material through the throat of the stirring tool. In embodiments, the filler material is a powder, the throat of the tool is a hollow cylinder, and an auger shaped member disposed within the throat of the tool is used to force powder material through the throat of the tool onto the substrate. The filler material can be delivered by pulling or pushing the filler material through the throat of the stirring tool.

Additional embodiments can comprise an additive friction stir tool comprising: a non-consumable body formed from material capable of resisting deformation when subject to frictional heating and compressive loading; a throat with an internal shape defining a passageway lengthwise through the non-consumable body; an auger disposed within the tool throat with means for rotating the auger at a different velocity than the tool and for pushing powdered filler material through the tool throat; whereby the non-consumable body is operably configured for imposing frictional and adiabatic heating and compressive loading of the filler material against a substrate resulting in plasticizing of the filler material and substrate.

In embodiments, the tool and auger preferably rotate relative to the substrate. In further embodiments, the tool and auger rotate relative to one another, i.e., there is a difference in rotational velocity between the auger and the tool body. There may be some relative rotation between the filler material and the substrate, tool, or auger. The filler material and tool are preferably not attached to one another to allow for continuous or semi-continuous feeding or deposition of the filler material through the throat of the tool.

For example, the filler material to be joined with the substrate may be applied to the substrate surface using a “push” method, where a rotating-plunging tool, e.g., auger, pushes the filler material through the rotating tool, such as a spindle. Feed material can be introduced to the tool in various ways, including by providing an infinite amount of filler material into the tool body from a refillable container in operable communication with the tool.

In embodiments, the filler material is a powdered solid and is fed through the tool body using an auger shaped plunging tool (e.g., a threaded member). In such an embodiment, the plunging tool may or may not be designed to move or “plunge” in a direction toward the substrate. For example, the threaded configuration of the auger itself is capable of providing sufficient force on the powdered feed material to direct the filler material toward the substrate for deposition, without needing vertical movement of the auger relative to the tool.

As the spindle and plunging tool rotate, compressive loading and frictional heating of the filler material can be performed by pressing the filler material into the substrate surface with the downward force (force toward substrate) and rotating speed of the additive friction stir tool.

During the metal joining process, it is preferred that the spindle rotate at a slightly slower rate than the auger. Alternatively, in embodiments, the spindle can also be caused to rotate faster than the auger. What is important in embodiments is that there is relative rotation between the spindle and the auger during application of the filler material. Due to the difference in rotational velocities, the threaded portion of the auger provides means for pushing the filler material through the tool body to force the material out of the tool toward the substrate. The threads impart a force on the feedstock that pushes the feed material toward the substrate much like a linear actuator or pneumatic cylinder or other mechanical force pushing on a surface of the feedstock. Even further, it may be desired in some applications to alter the rotational velocity of the tool body and/or auger during deposition of the filler material.

Deposition rate of the filler material on the substrate can be adjusted by varying parameters such as the difference in rotational velocity between the auger screw and the spindle, or by modifying the pitch of the threads on the auger. If desired, for particular applications it may be warranted to control filler material temperature inside or outside of the tool body with for example an external heat source. Such thermally induced softening of the filler material can increase the rate of application of the material.

In the context of this specification, the terms “filler material,” “consumable material,” “consumable filler material”, “feed material,” “feedstock” and the like may be used interchangeably to refer to the material that is applied to the substrate from the additive friction fabrication tooling. In an embodiment, a powder filler material is used in combination with an auger disposed in the tool throat for applying a constant displacement to the filler material within the throat.

The filler material (for example, powder or solid feedstock) can be fed through the rotating spindle to exit the tool where frictional heating occurs at the filler/substrate interface due to the rotational motion of the filler and the downward force applied. The frictional and adiabatic heating that occurs at the interface acts to plastically deform the substrate and filler material at the interface resulting in a metallurgical bond between the substrate and filler.

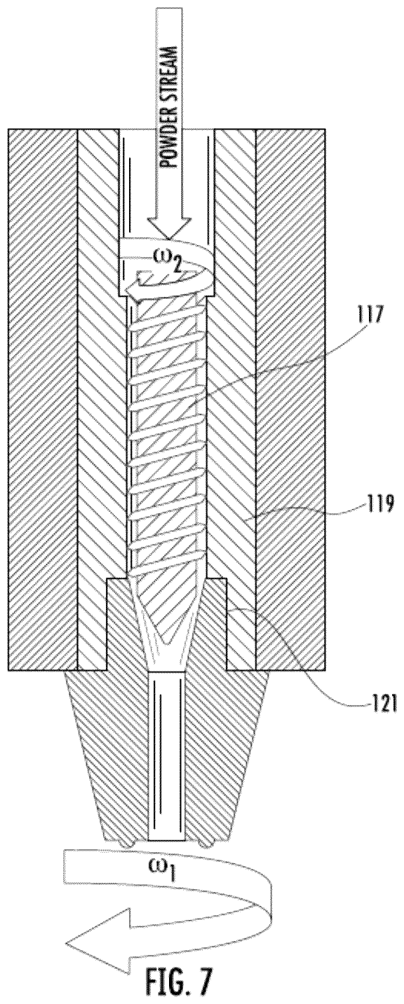

A mechanism as shown in FIG. 7 can be used to feed powder into the spindle and force the powder out of the spindle while ensuring the filler is keyed into the spindle. This system utilizes an auger screw 117 to force powder through the spindle at a defined rate, which is one means capable of accomplishing this purpose. Additional methods of feeding solid stock keyed into the orientation of the spindle and rotating at the exact rate of the spindle are conceivable. For example, force can be applied to the filler material using a metal rolling mill type mechanism which is rotating with the spindle.

In such an embodiment, the spindle is spinning at a desired rotational velocity and the auger screw is driven at a different rotational speed in the same rotational direction which acts to force material out of the spindle. As shown in FIG. 7, the angular rotational speed or velocity of the friction stir tool is identified as ω1 and the angular rotational velocity of the auger is identified as ω2. In the context of this specification, the terms “rotational speed,” “rotational velocity,” “angular speed,” and “angular velocity” can be used interchangeably and refer to the angular velocity of a component of the tool during use. The auger screw can rotate at a slower speed than the spindle, or in preferred embodiments the auger screw can rotate faster than the spindle. What is important is that there is relative rotation between the spindle and auger to cause filler material to be forced through the throat of the tool.

The pitch of the threaded auger screw and the volumetric pitch rate of the screw will affect the deposition rate under certain circumstances and can be modified to accomplish particular goals. It is within the skill of the art to modify the pitch of the threads on the auger to obtain a certain desired result. The terms “tool,” “friction stir tool,” “spindle,” “tool body,” and the like as used in this specification may be used to refer to the outer portion of the tool body, which comprises a passageway lengthwise through the tool for holding and dispensing feed material through the tool. This passageway, or throat, is generally the shape of a hollow cylinder. The hollow cylinder can be configured to have a wider opening at the top of the tool for accommodating the auger and powder material and a smaller opening at the base of the tool where the feed material is dispensed from the tool. Thus, the shape of the throat of the tool need not be consistent throughout the length of the tool throat and can be configured to converge from one lengthwise end of the tool to the other. As shown in FIG. 7, the throat of the tool can comprise a first region which is the shape of a hollow cylinder of a first diameter. This region can transition into a second region which is the shape of a hollow cylinder of a second smaller diameter. The transition region can be a converging hollow cylinder or funnel shaped region to allow the first and second region to be connected seamlessly.

Disposed within the tool body is an auger 117. In the context of this specification, the terms “auger,” “screw,” and “plunger” may be used to refer to a component of the tool that is disposed within the tool throat for pushing or pulling material through the throat. In embodiments, the auger can be considered a component of the friction stir tool body. The auger can have the general shape of a screw with threads, as shown in FIG. 7, or can be shaped in a spiral configuration similar to a spring. When disposed within the tool throat, there may be clearance between the auger 117 and the inside surface of the tool throat to allow for the passage of feed material between the auger and the throat. The inside of the surface of the tool throat includes sleeve 119 and bore 121. In other embodiments, there is only enough space to allow for rotation of the auger without interference from the surface of the throat. Preferably, the auger and tool body or spindle are not attached to one another. Each is operably connected with means for rotating and translating the components relative to a substrate surface, such that the auger and tool can rotate at different speeds but translate relative to the substrate at the same speed. It is preferred to keep the auger disposed within the tool throat in a manner such that there is no relative translational movement between the auger and tool body.

Powdered materials can be fed into the top of the spindle using a fluidized powder delivery system. Any type of powder delivery system can be used in connection with the tools and systems of the present invention. For example, a gravity-fed powder feeder system can be used, such as a hopper. One such feed system is the Palmer P-Series Volumetric Powder Feeder from Palmer Manufacturing of Springfield Ohio, which is capable of delivering feed material from 0.1-140 cu. ft. per hour, and which comprises a flexible polyurethane hopper, stainless steel massaging paddles, 304 stainless steel feed tube and auger, 90-volt DC gearhead drive motor, flexible roller chain drive system, sealed drive train and cabinet, and solid state control and pushbutton controls. The feed system preferably comprises a reservoir for holding powder filler material, a mixer for mixing powder(s) added to the reservoir, and a passageway for delivering feed material from the hopper to the throat of the tool body. As feed material is dispensed into and from the tool, more feed material is delivered into the tool from the hopper. In this manner, the feed material is continuously or semi-continuously delivered. The gravity-fed dispensing systems allow for feed material to automatically be dispensed from the hopper to the friction stir tool during use as soon as material within the tool is dispensed.

In embodiments, a mix of powder types can be added to the hopper which is operably connected with the stir tool. Alternatively, several different types of powder can be added individually to the hopper, then mixed within the hopper and dispensed as a mixture to the friction stir tool during use. For example, a metal powder and ceramic powder could be fed into the spindle at the same time, from the same or separate hoppers, and upon consolidation/deposition the filler would be a metal matrix composite (MMC). As used herein, the term “metal matrix composite” means a material having a continuous metallic phase having another discontinuous phase dispersed therein. The metal matrix may comprise a pure metal, metal alloy or intermetallic. The discontinuous phase may comprise a ceramic such as a carbide, boride, nitride and/or oxide. Some examples of discontinuous ceramic phases include SiC, TiB2 and Al₂O₃. The discontinuous phase may also comprise an intermetallic such as various types of aluminides and the like. Titanium aluminides such as TiAl and nickel aluminides such as Ni3Al may be provided as the discontinuous phase. The metal matrix may typically comprise Al, Cu, Ni, Mg, Ti, Fe and the like.

### Example

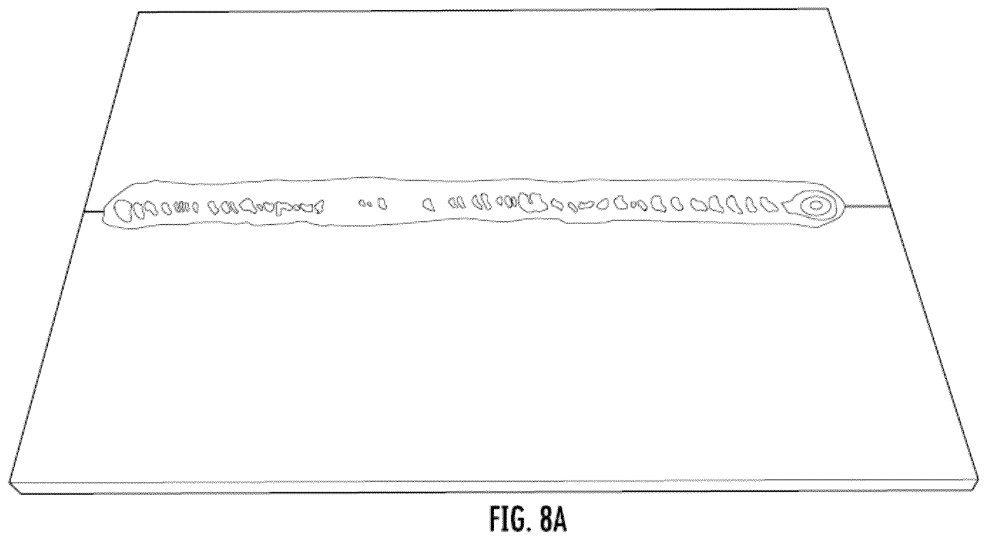

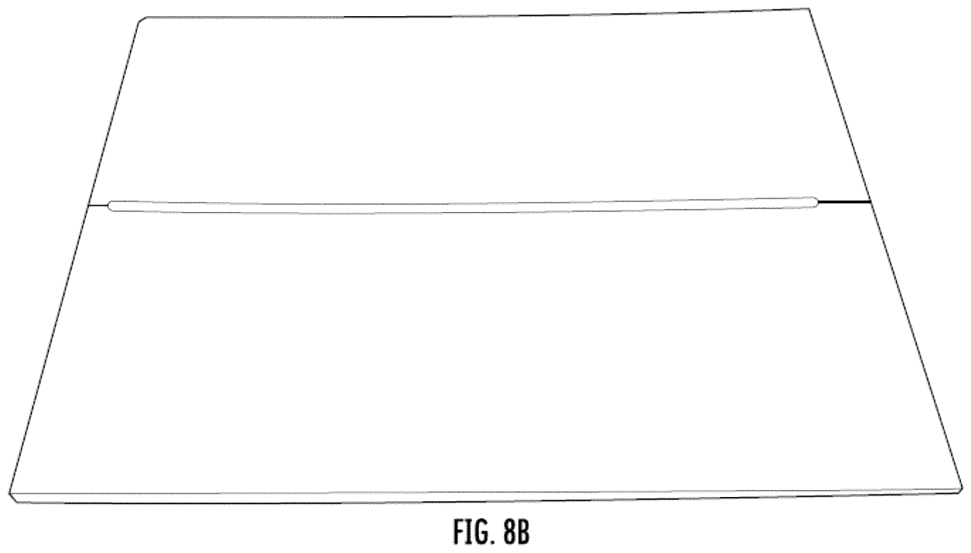

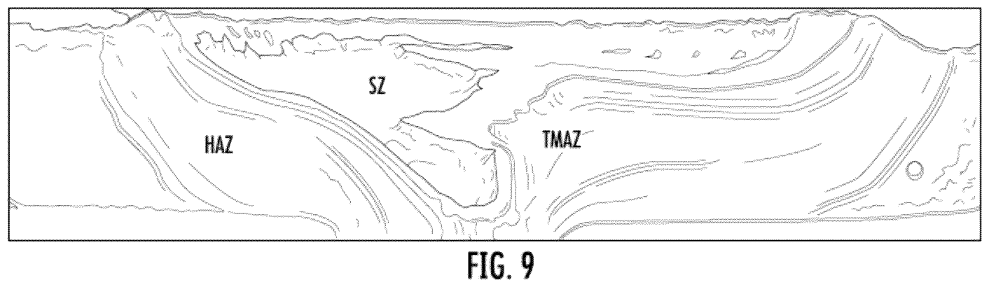

Diagrams showing substrates joined using an embodiment of the additive friction stir methods of the invention are provided in FIGS. 8A-B, and 9. In particular, two HY 80 steel substrates were welded together with a filler material comprising HY 80. HY-80 steel is an alloy comprising several metals. Typically, HY-80 steel comprises on a percent by weight basis about 93-97% Iron (Fe), about 2 4% Nickel (Ni), about 1 2% Chromium (Cr), <about 0.25% Copper (Cu), about 0.2 0.6% Molybdenum (Mo), about 0.15 0.35% Silicon (Si), about 0.12-0.18% Carbon (C), about 0.1 0.4% Manganese (Mn), <about 0.025% Phosphorous (P), <about 0.025% Sulfur (S), <about 0.020% Titanium (Ti), and <about 0.030% Vanadium (V). The density of HY-80 steel is typically about 7.87 g/cc and the melting point is around 1424° C. FIG. 8A shows one side of the substrates joined and FIG. 8B shows the other side of the substrates facing in an opposing direction. As illustrated, the deposited filler material can be seen on the face of the substrates at the face side of the weld where the rotating tool impressions are visible across the surface of the substrates in the filler material deposited on the substrates. Likewise, on the root side of the weld, the deposited filler material is visible as a minimal root projecting from the opposite side of the substrates. FIG. 9 provides a diagram of a cross section of the weld shown in FIGS. 8A-B. As illustrated, FIG. 9 demonstrates that a full penetration joint can be achieved. For convenience, some of the various regions of the weld are labeled, including a thermo-mechanically affected zone (TMAZ), a heat affected zone (HAZ), and a stirred zone (SZ).

According to other embodiments, the present invention provides for an additive friction stir method for fabricating a rib joined to a metallic substrate through extrusion, comprising:
providing a metallic substrate and a die assembly, wherein the metallic substrate is disposed on top of the die assembly, and the die assembly comprises a forming cavity disposed within the die assembly;
translating a rotating non-consumable friction-stir tool along the surface of the metallic substrate along a vector that overlies the forming cavity;
wherein the translating can be performed in any direction; and
feeding the rotating non-consumable friction-stir tool with a consumable filler material such that interaction of the rotating non-consumable friction-stir tool with the substrate generates plastic deformation at an interface between the rotating non-consumable friction-stir tool and the metallic substrate such that the consumable filler and metallic substrate are extruded through the forming cavity and optionally bonded together to form a rib joined to the metallic substrate.

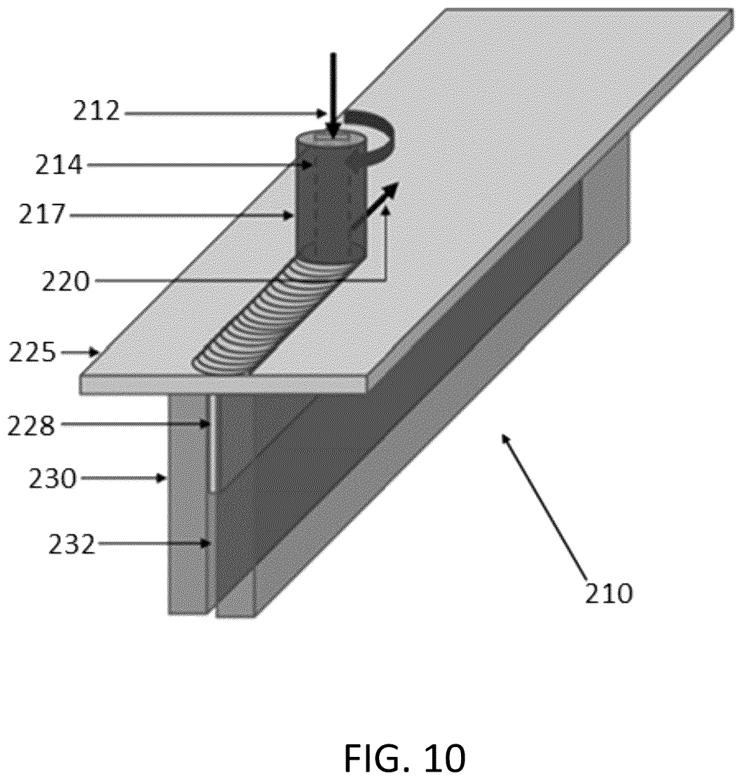

FIG. 10 schematically shows an exemplary rib extrusion process 210. The metallic substrate 225 on which the stiffening ribs are formed is firmly held on top of a forming die assembly 230, where the forming die or die assemblies 230 are specifically designed to meet the required rib geometry. Upon interaction of the rotating additive friction stir (AFS) tool 217 with filler material 214 with the surface of the substrate 225, frictional and adiabatic heat is generated with a severe plastic deformation at the tool-substrate interface. The temperature and plastic deformation is sufficient to form a solid state bonding between the filler 214 and the substrate 225. The setup creates a localized extrusion chamber for plastically deformed material (e.g., substrate and/or filler) to enter from above. For example, in a typical set up, forming die 230 is disposed under the substrate 225 and the forming die 230 provides the walls of the extrusion chamber. Material from the substrate 225 and/or filler material from the AFS tool 217 is plastically deformed above the forming die 230 and is extruded into the forming die 230 below to take the shape of the interior of the forming die 230 defined by the forming die walls. An increase in filler feed force 212 at this condition extrudes the plasticized filler metal into the cavity 232 or groove of the forming die assembly. Upon translation 220 the rotating AFS tool 217 is moved along the top of the substrate 225 overlying the forming cavity 232 or groove so that the plastically deformed filler 214 and metallic substrate 225 feeds the localized extrusion chamber 232 resulting in continuous extrusion of the stiffening ribs 228. Depending on the rib geometry requirements, the rib extrusion can be achieved in single or multiple steps with or without the addition of preformed ribs. The method of rib fabrication on a metallic substrate without the addition of preformed ribs is referred to in this disclosure as monolithic localized rib extrusion; and the method of rib fabrication with addition of one or more preformed ribs is referred to in this disclosure as rib extrusion with joining. Multiple ribs and intersecting ribs can be formed on a single metallic substrate using single or multiple AFS tools, for example with the tools in tandem and/or in parallel with one another.

The friction-based rib fabrication process of the present invention may be used to join a rib or ribs onto various types of metallic substrates including but not limited to, metal substrates comprising Al, Ni, Cu, Mg, Ti, and Fe, as well as, alloys of two or more of these metals and the like. In further embodiments, the rib-fabrication process may also be used to join one or more ribs onto polymeric substrates and various composites thereof. Non-limiting examples of polymeric substrates include any deformable materials such as plastics and the like. Usually plastics are a homo-polymer or co-polymer of high molecular weight. Plastics useful to embodiments of the invention described herein include, but are not limited to, polyolefins, polyesters, nylons, vinyls, polyvinyls, polyethylene terephthalate (PET or PETE), high density polyethylene (HDPE), low density polyethylene (LDPE), polyvinyl chloride (PVC), polypropylene, polycarbonate, polyactide, acrylics, polyacrylics, polycarbonates, polystyrenes, polyurethanes, and the like. In still yet another embodiment, the rib-fabrication process may also be used to join one or more ribs onto a substrate that is a composite material comprising at least one metallic material and at least one polymeric material.

Substrates may take on a variety of forms and can for example be in the form of a sheet or plate of any thickness (e.g., sheet metal) such as steel, aluminum, and the like.

In this additive friction stir rib fabrication process embodiment, the filler material (for example, solid bar or powder) can be fed through the rotating additive friction stir tool where frictional and adiabatic heating occurs at the filler/substrate interface due to the rotational motion of the filler and the downward force applied. The frictional and adiabatic heating that occurs at the interface results in a severe plastic deformation at the tool-metal interface. As the tool moves along a vector overlying the forming cavity (or with any relative motion between the substrate and tool), the rib can be extruded under the rotating shoulder of the tool.

One embodiment of the present invention provides a friction-based rib fabrication method, in which filler material is joined with a metallic substrate and subsequently bonded with the substrate using additive friction stir processing. The filler material may be of a similar or dissimilar material as that of substrate material. In a particular embodiment, the filler material is a metallic material. Non-limiting examples of metallic materials useful as a filler material include Al, Ni, Cu, Mg, Ti, and Fe, as well as alloys of two or more of these metals and the like. In another embodiment, the filler material is a polymeric material. Non-limiting examples of polymeric materials useful as a filler material include polyolefins, polyesters, nylons, vinyls, polyvinyls, acrylics, polyacrylics, polycarbonates, polystyrenes, polyurethanes, and the like, or any of the plastics listed elsewhere in this disclosure. In still yet another embodiment, the filler material is a composite material comprising at least one metallic material and at least one polymeric material. In other embodiments, multiple material combinations may be used for producing a composite at the interface. The composite material is then extruded into a forming cavity of a die assembly disposed below the substrate.

The filler materials can be in several forms, including but not limited to: 1) powder or rod of a single or composite composition; 2) matrix metal and reinforcement powders can be mixed and used as feed material; or 3) a solid rod of matrix can be bored (e.g., to create a tube or other hollow cylinder type structure) and filled with reinforcement powder, or mixtures of metal matric composite and reinforcement material. In the latter, mixing of the matrix and reinforcement can occur further during the fabrication process. In embodiments, the filler material may be a solid metal rod.

In embodiments, the filler material is joined with a substrate using frictional heating and compressive loading of the filler material against the substrate and a translation of the rotating friction tool. The filler material may be a consumable material, meaning as frictional heating and compressive loading are applied during the process, the filler material is consumed from its original form and is applied to the substrate. Such consumable materials can be in any form including powders, pellets, rods, and powdered-filled cylinders, to name a few. More particularly, as the applied load is increased, the filler material and substrate at the tool-substrate interface become malleable as a result of frictional and adiabatic heating and are caused to bond together under the compressive load. In embodiments, the deformed metal is then extruded into the groove of the die assembly below the substrate.

Such methods, for example, can include methods for friction-based rib extrusion comprising: (a) compressive loading of a filler material against a surface of a substrate using a rotating tool; (b) frictional and adiabatic heating of the filler material on the substrate surface using the rotating tool to form a composite between the filler material and substrate; (c) translation of the stirring tool relative to the substrate surface along a vector that overlies a forming cavity of a die assembly underlying the substrate; and/or (d) extrusion of the composite into the forming cavity.

In an embodiment, the cavity comprises an open end at the bottom of the die assembly such that the rib is extruded through the die assembly. In another embodiment, the cavity comprises a closed end at the bottom of the die assembly such that extrusion of the rib terminates at the closed end.

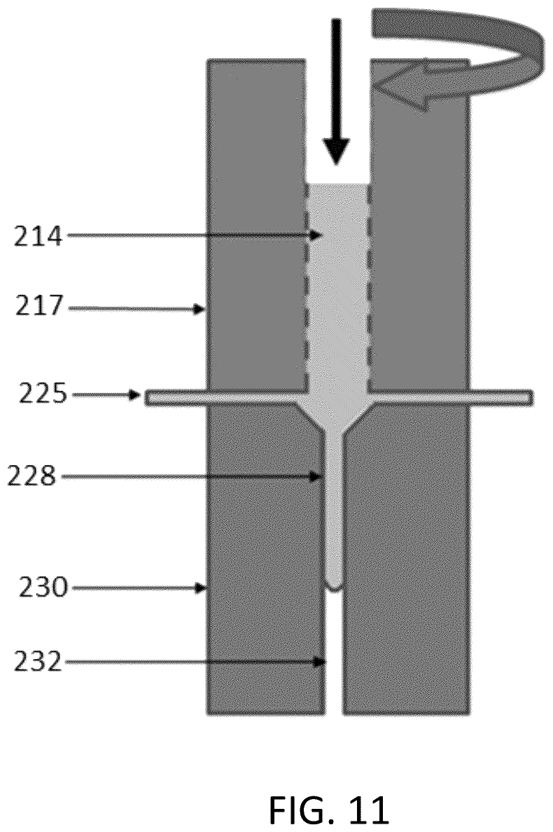

The monolithic rib extrusion process is further depicted in the embodiment shown in FIG. 11, in which there is no addition of preformed ribs (e.g., the forming cavity is empty and no material is provided in the forming cavity). In this case at least the volume of filler material 214 required to form the rib is added through the tool 217. The rib formation can be with an open die 230 or alternatively closed die assembly. The closed die assembly is used to fabricate ribs with uniform height while the open die assembly is flexible and economical.

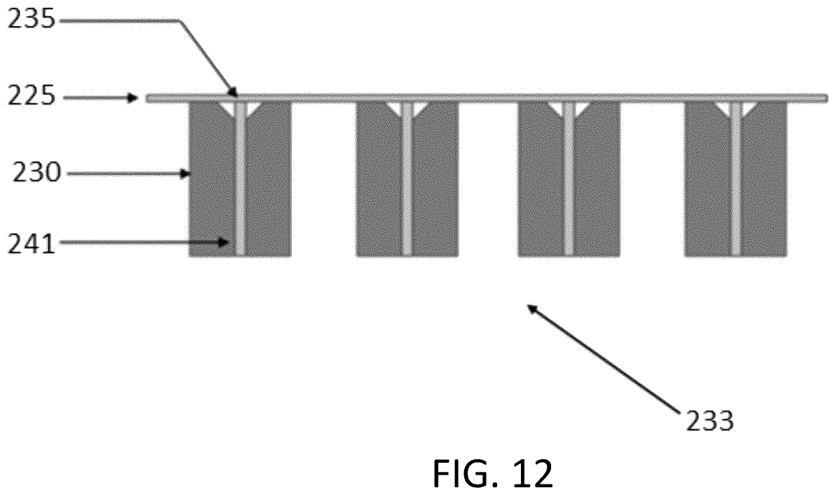

Additional embodiments provide for a performed rib within the cavity of the die assembly, particularly where the extrusion of the rib is coupled with joining of the extruded rib to the preformed rib. FIG. 12 shows the rib extrusion process 233 with joining. In this embodiment the preformed ribs 241 are added in the forming grooves, resulting in coupling of rib extrusion with joining. The location of joining and seam extrusion is shown by element 235. Additionally, embodiments include the provision of multiple metallic substrates disposed on top of a single forming die assembly or multiple forming die assemblies provided under a single substrate. Since the extrusion and joining is integrated together the base metal substrate can be of multiple strips instead of one large sheet. Further, in other embodiments, multiple die assemblies are provided with preformed ribs and the metallic substrate is disposed on top of the die assembles to provide for the formation of multiple preformed ribs. During extrusion the metallic substrate is additionally joined with the preformed rib to form a preferred fillet at the intersection. In the context of this specification, it is not critical whether the substrate is provided above the die assembly, however, this arrangement may be preferred such that the extrusion can take advantage of gravity in delivering plastically deformed substrate and/or filler material to the forming cavity of the die assembly. A reverse orientation is also possible with the substrate disposed below the die assembly, or the processing can be performed sideways or at any angle in between as well.

The preformed ribs can be of any simple extrusion geometries in addition to the geometries shown in FIG. 13. Embodiments of preformed ribs may include I-shaped, as well as L-shaped 252, Y-shaped 254, or T-shaped 256 as shown in FIG. 13.

According to embodiments, the additive friction stir process, tool, and system of the present invention can be used to join any preformed feature or structure onto various types of metallic substrates including but not limited to, metal substrates comprising Al, Ni, Cu, Mg, Ti, and Fe, as well as, alloys of two or more of these metals and the like. In further embodiments, the inventive additive friction stir process, tool, and system may also be used to join one or more preformed feature or structure onto polymeric substrates and various composites thereof. Non-limiting examples of polymeric substrates include any deformable materials such as plastics and the like. Usually plastics are a homo-polymer or co-polymer of high molecular weight. Plastics useful to embodiments of the invention described herein include, but are not limited to, polyolefins, polyesters, nylons, vinyls, polyvinyls, polyethylene terephthalate (PET or PETE), high density polyethylene (HDPE), low density polyethylene (LDPE), polyvinyl chloride (PVC), polypropylene, polycarbonate, polyactide, acrylics, polyacrylics, polycarbonates, polystyrenes, polyurethanes, and the like. In still yet another embodiment, the additive friction stir process, tool, and system may also be used to join one or more preformed feature or structure onto a substrate that is a composite material comprising at least one metallic material and at least one polymeric material. In some embodiments, the preformed feature or structure being added comprises the same, similar or different material(s) than the substrate to which it is added.

In some aspects, the additive manufacturing process, tool, and system are used to attach a preformed feature or structure, such as flanges, bosses, gaskets, fittings, centralizers and others, to a cast part or substrate or a part made by any other means by the joining process.

In other aspects, the additive manufacturing process, tool, and system are used to print (build-up) the feature that needs to be added to a cast part or a substrate or a part made by any other means.

In some embodiments, a hollow tool with extended hollow pin is used to join the feature to the cast part. In other embodiments, only a hollow tool is used to perform the joining process.

In some embodiments, cylindrical, annular and other features, already made by other means, are attached or incorporated into cast parts by the solid-state additive joining process. The solid state additive manufacturing process adds a filler material to the joint. The filler material can be customized to be the same, similar or different than the base material or the feature that is being added.

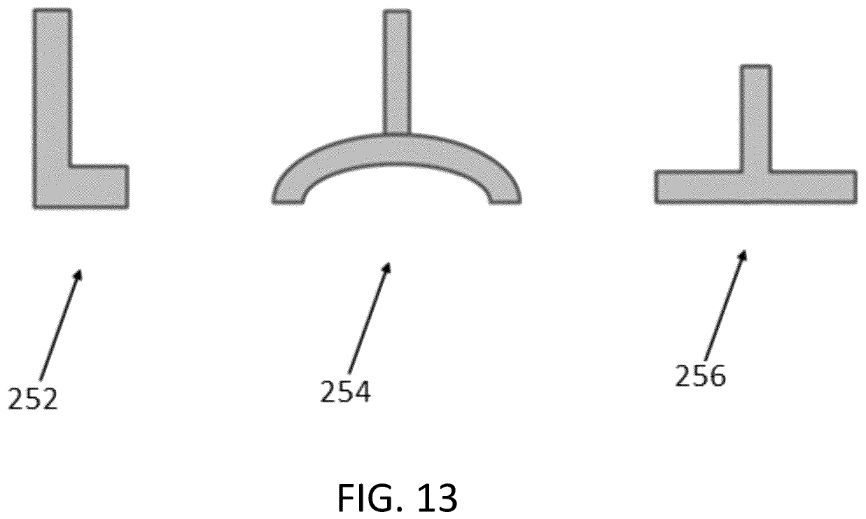

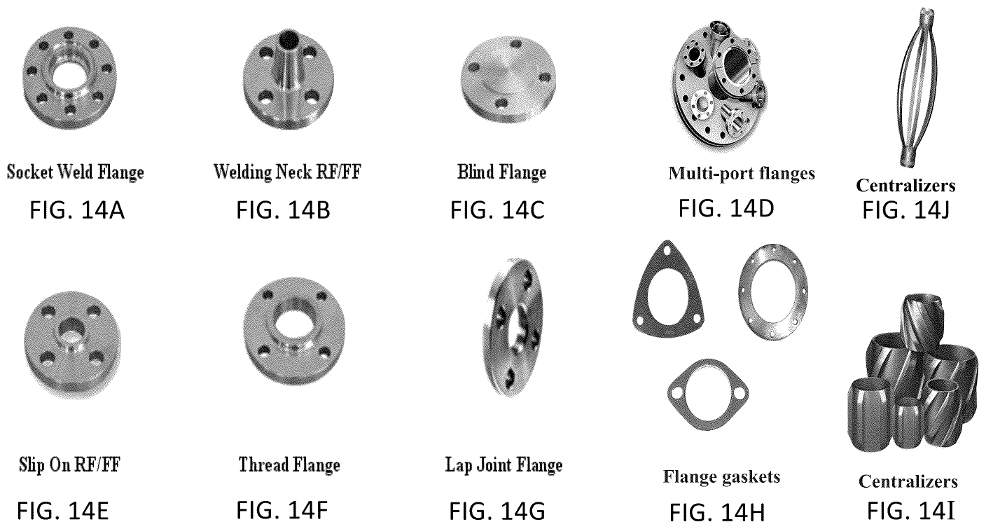

In some embodiments, the features are different types of flanges, such as but not limited to weld-neck flanges, threaded flanges, socket-weld flanges, slip-on flanges, lap joint flanges, blind flanges, long-weld-neck flanges, tube-sheet flanges, multi-port flanges, split flanges, spectacle-blind flanges, orifice flanges, multi-port flanges, different types of bosses, multi-port hollow structures, forged fittings, gaskets, etc. Some of the features that can be joined to cast parts by the solid-state joining process are shown in FIGS. 14A-14I.

In another embodiment, the flanges are of any geometry including but not limited to hollow ring, hollow triangle, hollow square, hollow rectangle, hollow pentagon or any other hollow shape. For example, the flanges can be configured as a solid ring, solid triangle, solid square, solid rectangle and/or any other solid shape.

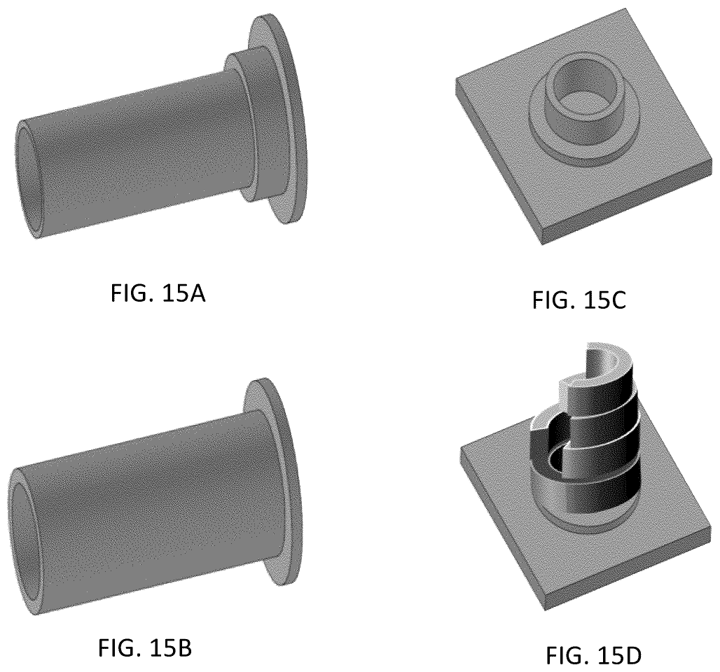

Features like flanges and bosses can be joined to already cast metal parts. For instance, the features presented in FIGS. 14A-14I that are manufactured previously (by any other means) can be added to a previously made pipe or a flat substrate with a solid-state additive joining process, as shown in FIGS. 15A-C.

In some aspects of the invention, the manufacturing process and system are used to perform both joining and 3D printing of the feature or structure to be added. First, the process and system are used to join a partially-formed feature made by other means, and then, the process and system are used to deposit a filler material on the partial feature into the final desired feature shape. This is particularly useful when asymmetric features need to be joined to cast parts or other parts, substrate or hollow structures like pipes. The reason for this is that the molding/casting process limits the manufacture of asymmetrical structures but can be successfully used for making an initial symmetric structure, which can be later joined by joining to a part or substrate. Then the system and process are used to deposit the filler material on the attached feature and build it into a desired asymmetrical shape.

In a particular embodiment, asymmetrical features are printed (built up) on cast parts that are hard or prohibited to be manufactured by casting or other conventional methods. The system and process are capable of fully building up the asymmetric feature. In another embodiment the system and process are capable of completing the asymmetric or symmetric feature from a feature made by other means (FIG. 15D).

In another embodiment, a cast generic shape is added to a tubular or other assembly produced by conventional means, and then the additive manufacturing system is used to join such generic structure to the part and perform delayed differentiation, i.e. complete (build up) the final shape of the generic structure by printing additional features on the generic piece.

In some embodiments, symmetrical features are added to a tubular or other assembly. In a particular embodiment, the symmetrical feature is cast aside and then joined to the assembly by the joining process. In another embodiment, the symmetrical feature is manufactured in situ by the 3D printing process.

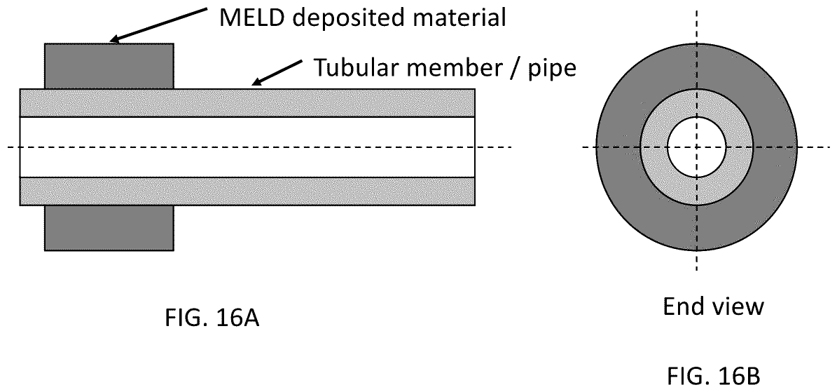

In some embodiments, an additive structure can be added to a pipe or other cast part at any location without affecting the whole pipe, part, or structure. For instance, in some embodiments, the additive manufacturing system and process are capable of adding (printing) a structure along any portion of a long pipe without affecting the pipe, the end fittings, the pipe material and without any need for post-treatments required by conventional joining processes (e.g. welding). In a particular embodiment, the process can be used to add material (304/316L) that will not be sensitized or otherwise negatively affected by traditional welding processes (e.g. tungsten inert gas (TIG), metal inert gas (MIG), flux-cored arc welding (FCAW), and so on). The process parameters can be adjusted to have minimal or no negative impact at all on the pipe material (high chrome steels, low carbon steels, etc.) which may not be welded without additional processing such as post welding heat treatment (PWHT). By adding material processed using the system to targeted locations, manufacturers can attach other components to their tubular or other assemblies by way of the additive joining process without the need for PWHT (FIGS. 16A and 16B).

In one embodiment, materials that have a higher melting temperature or that are denser or harder serve as the part/substrate, and materials that have a lower melting temperature or are less dense or lighter serve as the filler material.

The filler material used in the joining process can be the same or similar material to the base material (e.g. pipe, substrate) that the feature is added to, or can be the same or similar material to the material of the feature or structure that is being added or can be a very different type of material than either or both materials that are being joined. The joining process, which is done in a solid state would cause a severe local plastic deformation and a local mixing of the materials, and thus, provide good metallurgical bonding.

In another embodiment, the preformed features are added to plastic substrates, structures or parts made by other means, such as extrusion, injection, molding, and so on. The preformed features can be made of metal, metal alloy, plastic, composite or hybrid material. During the joining process, an appropriate filler material and appropriate processing conditions are used to connect and bond the feature to the base material. The filler material can be a composite material with components resembling the base material and the material of the feature being added or can be a reinforced material or any material that is capable of providing better bonding than the traditional use of adhesive in this kind of application.

In one embodiment, a centralizer is added to a tubular structure (pipe). The centralizer is a previously made feature and by means of a joining process is added to an already made tubular structure.

In another embodiment the centralizer is printed using the additive manufacturing system in the desired location of a given tubular structure (pipe) or any other assembly.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure including patents, published patent applications, and non-patent literature are each individually incorporated by reference herein in their entireties and as such are intended to provide an efficient way of supplementing the enabling disclosure of this invention as well as provide background detailing the level of ordinary skill in the art.

1. A method for solid-state joining, comprising:
placing one or more substrate in communication with one or more feature;
feeding feedstock through a throat of a rotatable and translatable tool, which throat is configured to exert one or more force on a surface of the feedstock; and
rotating and translating the tool relative to the feature and the substrate such that frictional heat results in deformation of the feedstock and allows for joining of the one or more feature and the one or more substrate.

2. The method of claim 1, wherein the force is a normal and/or tangential force.

3. The method of claim 1, wherein the feature comprises a flange, boss, gasket, and/or centralizer.

4. The method of claim 1, wherein the tool is rotated and translated, in whole or part, around one or more edges of one or more of the features such that the feedstock forms a joint between one or more of the features and one or more of the substrates.

5. The method of claim 3, wherein the tool is rotated and translated, in whole or part, around one or more edges of one or more of the flange, boss, gasket, and/or centralizer, such that the feedstock forms a joint between one or more of the flange, boss, gasket, and/or centralizer and one or more of the substrates.

6. The method of claim 1, wherein one or more of the features and one or more of the substrates are joined with a feedstock which is the same material as a material of one or more of the features and/or as a material of one or more of the substrates.

7. The method of claim 1, wherein one or more of the features and one or more of the substrates comprise the same material or materials.

8. The method of claim 1, wherein one or more of the features and one or more of the substrates comprise different materials.

9. The method of claim 1, wherein the feedstock comprises a powder, pellet, rod, and/or powdered-filled hollow structure.

10. The method of claim 1, wherein one or more of the features and/or one or more of the substrates and/or the feedstock each comprise a material independently chosen from metals, metallic materials, metal matrix composites (MMCs), polymers, polymeric materials, ceramics, ceramic materials, steel, Al, Ni, Cr, Cu, Co, Au, Ag, Mg, Cd, Pb, Pt, Ti, Zn, Fe, Nb, Ta, Mo, W, or an alloy comprising one or more of these metals, as well as combinations of any of these.

11. The method of claim 1, wherein one or more of the substrates is a cast part.

12. The method of claim 3, wherein one or more of the substrates is a cast part.

13. The method of claim 3, wherein one or more of the substrates has a flat geometry.

14. The method of claim 3, wherein one or more of the substrates has a circular geometry.

15. The method of claim 3, wherein one or more of the substrates is a pipe.

16. The method of claim 3, wherein one or more of the substrates has a hollow configuration.

17. The method of claim 16, wherein one or more of the substrates is a pipe.

18. The method of claim 1, wherein one or more of the features comprises a centralizer.

19. The method of claim 1, wherein one or more of the features is held against the substrate in a forming cavity, and the tool is rotated and translated relative to one or more of the substrates, such that extrusion of one or more of the substrates and/or the feedstock into the forming cavity allows for joining of one or more of the features with one or more of the substrates.

20. The method of claim 19, wherein one or more of the features comprises a flange, a boss, a centralizer, and/or a gasket.
